(19) United States
(12) Patent Application Publication
(10) Pub. No.: US 2005/0100246 A1
(43) Pub. Date: May 12, 2005

(54) Method of expanding a digital image

(75) Inventor: Seung-Cheol Lee, Gyeonggi-do (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/978,781

(22) Filed: Nov. 1, 2004

(30) Foreign Application Priority Data
Nov. 10, 2003 (KR) 79211/2003

(51) Int. Cl. G06K 9/32

(52) U.S. Cl. 382/300

(57) ABSTRACT

A method of expanding a digital image for preventing the discontinuity of an expanded image due to the change of the image signal using four pixels rather than two pixels as in the conventional method in analyzing the image signal. The method includes a first step of dividing an input image in the unit of four adjacent pixels, and dividing the four pixels into three sections; a second step of determining an interpolation function between the second and third pixels among the four adjacent pixels by analyzing the digital image every three sections; a third step of setting coordinate values for image expansion using the interpolation function determined at the second step; and a fourth step of obtaining an expanded image of the digital image by repeating the second and third steps until a last line of the digital image is processed.

### PRIORITY

This application claims priority to an application entitled “Method of Expanding Digital Image” filed in the Korean Industrial Property Office on Nov. 10, 2003 and assigned Serial No. 2003-79211, the contents of which are hereby incorporated by reference.

### BACKGROUND OF THE INVENTION

1. Field of the Invention

The present invention relates to a method of expanding a digital image for a digital video appliance.

2. Description of the Related Art

A typical analog image signal is converted into a digital image signal by quantization and sampling processes. Thereafter, the converted digital image signal can be provided through mobile communication systems, etc. Such a digital image has been widely used for mobile communications, multimedia services, etc. However, because a quantized and sampled digital image is discrete, there is a great difference between the digital image and the original image when receiving and expanding the digital image.

FIGS. 1A to 1C are views illustrating examples of typical analog and digital image signals. An analog image signal as illustrated in FIG. 1A, which is smooth without intermission, is converted into a discrete digital image signal as illustrated in FIG. 1C through quantization and sampling processes as illustrated in FIG. 2B.

A method of expanding a discrete digital image is classified into an up-sampling method and an interpolation method.

The up-sampling method expands a provided digital image by copying respective pixels of the digital image as illustrated in FIGS. 2A and 2B. That is, FIGS. 2A and 2B are views provided for explaining a conventional up-sampling type digital image expanding method.

In FIG. 2A, the original image is illustrated as an analog image indicated as a dotted line and a digital image indicated as points (i.e., pixels), and in FIG. 2B, a four-times expanded image is illustrated.

The expanded image of FIG. 2B is provided by copying the original digital image expressed as pixels as much as the scale of expansion and displaying the copied image. Accordingly, the up-sampling type digital image expanding method is easily implemented with a small amount of operation and therefore, is widely used in portable digital video appliances and on the like.

However, the up-sampling type image expanding method has the drawbacks in that because it expands the image by copying the same pixels and substituting the copied pixels for their adjacent pixels, an abrupt change of the image occurs between the pixels to cause a severe discontinuity of the image signal. As a result, the image is not smoothly displayed.

The interpolation method expands a digital image by obtaining a slope between pixels and adding pixels as much as the scale of expansion on a one-dimensional straight line connecting between the pixels.

FIGS. 3A to 3C are views illustrating a conventional interpolation type digital image expanding method. In FIG. 3A, the original image is illustrated as an analog image indicated as a dotted line and a digital image indicated as points (i.e., pixels). In FIG. 3B, a four-times expanded image obtained by an up-scaling method is illustrated. The respective pixels illustrated in FIG. 3B are obtained by the up-scaling method, and a dotted line indicates an analog image. Also, a straight line connecting the respective pixels (i.e., original pixels) indicated as a solid line is for the application of the interpolation method.

FIG. 3C is a view illustrating an image signal expanded by the interpolation method. By positioning the respective pixels on the straight line of FIG. 3B, the expanded image becomes more similar to the original analog image.

The interpolation method expands the image by interpolating the original image in accordance with the ratio of change between two pixels, and thus a smooth image can be obtained with pixels as units. However, the interpolation method also has drawbacks in that because it expands the image by performing an interpolation between pixels using a straight line, an abrupt change of image occurs in a bent portion of the straight line to cause distortion of the image.

FIGS. 4A and 4C illustrate the distortion caused by the conventional up-sampling method and interpolation method. More specifically, FIG. 4A illustrates the original analog image, FIG. 4B illustrates the up-sampled digital image, and FIG. 4C illustrates the interpolated digital image.

In the up-sampled digital image as illustrated in FIG. 4B, signal discontinuity and distortion occur in the unit of a pixel of the original image.

In the interpolated digital image as illustrated in FIG. 4C, the image signal between the pixels is similar to the original image signal, and the distortion caused by the expansion of the image is greatly reduced in comparison to the up-sampled image. However, in portions where the pixels are changed, i.e., increase and decrease, the one-dimensional straight line that connects the pixels of the original image cannot be smoothly connected with the one-dimensional straight line that connects the pixels of the next original image to cause the discontinuity of the image signal. As a result, the picture quality of the portions deteriorates.

### SUMMARY OF THE INVENTION

Accordingly, the present invention has been designed to solve the above and other problems occurring in the prior art, and an object of the present invention is to provide a method of expanding a digital image to prevent the discontinuity of an expanded image due to the change of the image signal using four pixels rather than two pixels as in the conventional method in analyzing the image signal.

Another object of the present invention is to provide a method of expanding a digital image to reduce distortion of the image in a video communication, a VOD (Video On Demand) service, etc., by widening a communication bandwidth by encoding the image with a small size and expanding and reproducing the image on a terminal side.

Still another object of the present invention is to provide a method of expanding a digital image to obtain a desired expanded image by heightening the scale of expansion of a digital zoom as a pre-processing step of the digital image obtaining.

In order to accomplish the above and other objects, there is provided a method of expanding a digital image. The method includes: dividing an input image in the unit of four adjacent pixels, and dividing the four pixels into three sections; determining an interpolation function between the second and third pixels among the four adjacent pixels by analyzing the digital image every three sections; setting coordinate values for image expansion using the interpolation function determined at the second step; and obtaining an expanded image of the digital image by repeating the second and third steps until a last line of the digital image.

### BRIEF DESCRIPTION OF THE DRAWINGS

The above and other objects, features, and advantages of the present invention will be more apparent from the following detailed description taken in conjunction with the accompanying drawings, in which:

FIGS. 1A to 1C are views illustrating examples of typical analog and digital image signals;

FIGS. 2A and 2B are views illustrating a conventional up-sampling type digital image expanding method;

FIGS. 3A to 3C are views illustrating a conventional interpolation type digital image expanding method;

FIGS. 4A and 4C are views illustrating distortion occurrence caused by a conventional up-sampling method and interpolation method;

FIG. 5 is a block diagram illustrating a multimedia data transmitting/receiving apparatus to which the present invention is applied;

FIGS. 6A to 6D are views provided for explaining interpolation methods for respective image signal types according to a method of expanding a digital image according to the present invention;

FIGS. 7A to 7C are views provided for explaining exceptional sections of interpolation methods for respective image signal types according to a method of expanding a digital image according to the present invention;

FIG. 8 is a flowchart illustrating a method of expanding a digital image according to the present invention; and

FIGS. 9A to 9C, 10A to 10C and 11A to 11C are views illustrating digital images expanded according to the present invention.

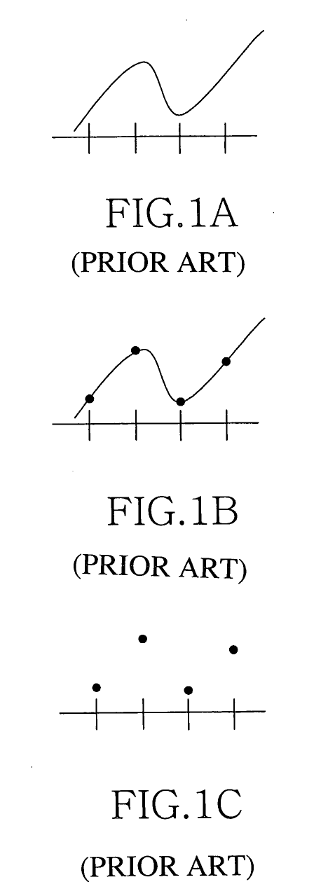

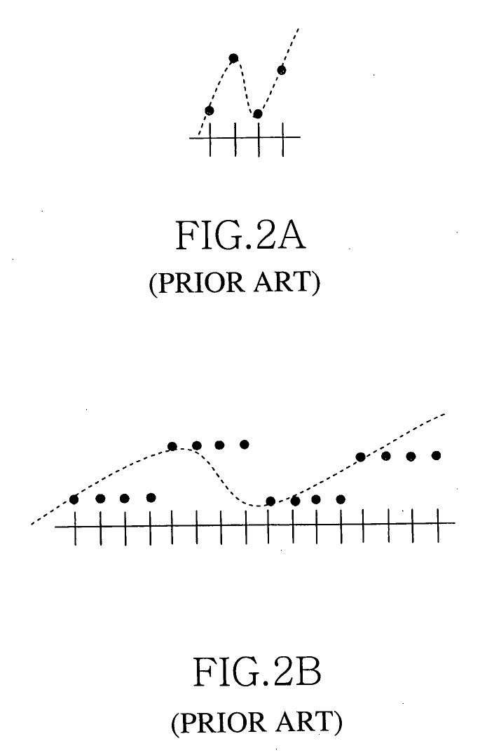

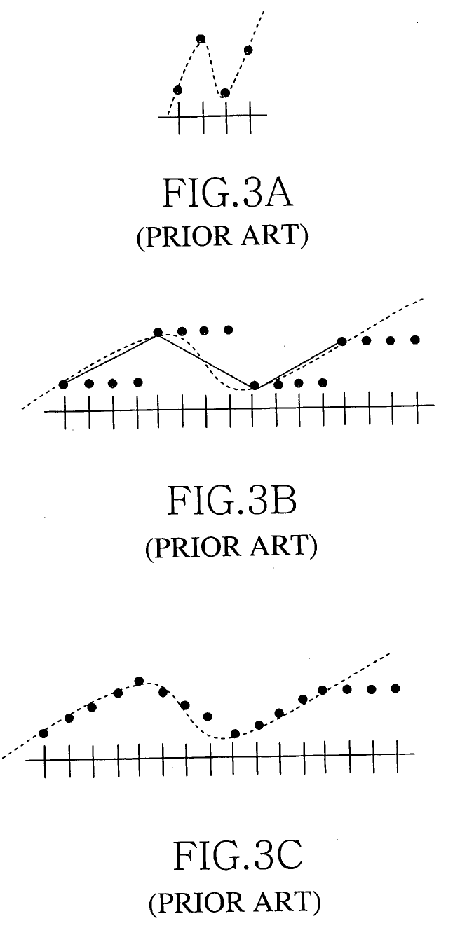

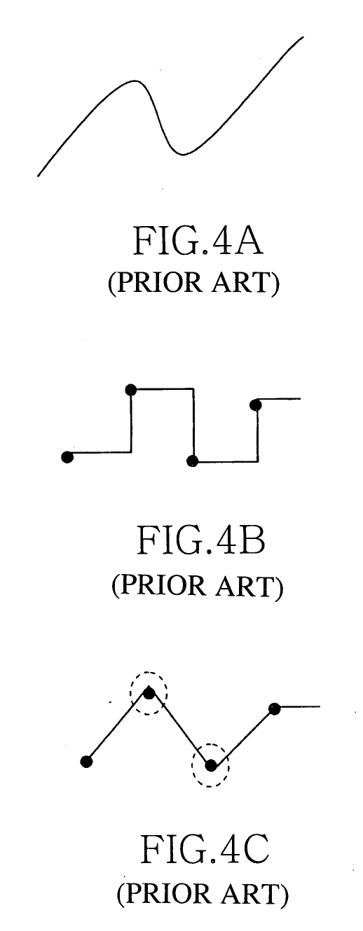

### DETAILED DESCRIPTION OF THE PREFERRED EMBODIMENT

Hereinafter, the method of expanding a digital image according to preferred embodiments of the present invention will be described with reference to the accompanying drawings. In the following description of the present invention, same drawing reference numerals are used for the same elements even in different drawings. Also, a detailed description of known functions and configurations incorporated herein will be omitted when it may obscure the subject matter of the present invention.

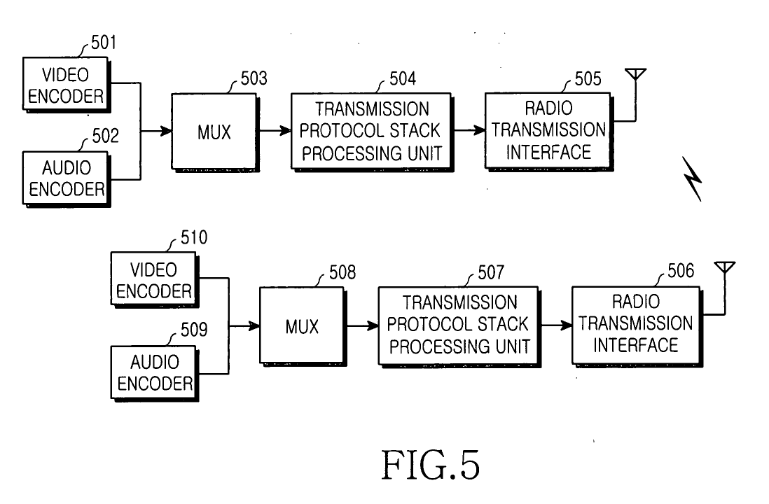

FIG. 5 is a block diagram illustrating a multimedia data transmitting/receiving apparatus to which the present invention is applied. As illustrated in FIG. 5, the multimedia data transmitting/receiving apparatus includes a transmitter having a video encoder 501 for encoding video data, an audio encoder 502 for encoding audio data, a multiplexer (MUX) 503 for multiplexing the encoded audio data and video data, a transmission protocol stack processing unit 504 for controlling a protocol for transmitting the multimedia data, and a radio transmission interface 505 for transmitting the multimedia data. The apparatus also includes a receiver having a radio transmission interface for receiving the multimedia data 506, a transmission protocol stack processing unit 507 for processing a protocol for transmitting the received multimedia data, a demultiplexer (DEMUX) 508 for dividing the multimedia data into video data and audio data to output the divided video data and audio data, an audio decoder 509 for decoding the audio data, and a video decoder 510 for decoding the video data.

The image expanding apparatus according to the present invention is provided to follow the video decoder 510, and receives and expands the image information decoded by the video decoder 510. Whereas the conventional interpolation method interpolate pixels on a straight line connecting two adjacent pixels, the image expanding method according to the present invention minimizes the image distortion during the image expansion by determining a change of four adjacent pixels by analyzing the four adjacent pixels and performing different interpolations according to the kind of the change.

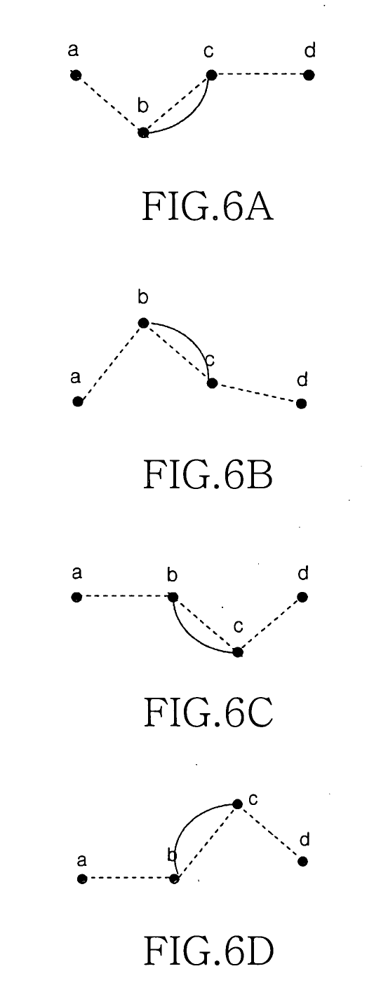

FIGS. 6A6A to 6D are views illustrating interpolation methods for respective image signal types according to a method of expanding a digital image according to the present invention. In the embodiment of the present invention, a method of determining a function for interpolation between two pixels b and c by analyzing four adjacent pixels a, b, c, and d. Here, g(x) denotes a signal function value corresponding to a pixel x of a digital image.

Referring to FIG. 6A, the function value of the four adjacent pixels is reduced (in a section a-b), increased (in a section b-c), and then not reduced again, i.e., remains constant (in a section c-d). In this case, the section b-c, which is concerned, is processed as a curve of a quadratic function. That is, if g(a)>g(b), g(b)<g(c), and g(c)<=g(d) with respect to the function g(x) that indicates the respective pixel values, the function between the pixel b and the pixel c is given by Equation (1) below.

$$[ f ( x ) = \{ g ( c ) - g ( b ) \} * {( x - b )}^{2} + g ( b ) \qquad ( 1 )$$

Here, b-a=c-b=d-c=1. That is, in the embodiment of the present invention as illustrated in FIG. 6A, if the function value of the pixels is changed from decrement to increment, unlike the conventional interpolation, the concerned section is processed as a curve using the quadratic function, and this prevents an abrupt change at a vertex.

Referring to FIG. 6B, the function value of the four adjacent pixels is increased (in the section a-b), decreased (in the section b-c), and then not increased again (in the section c-d). In this case, the concerned section b-c is processed as a curve of a quadratic function. That is, if g(a)<g(b), g(b)>g(c), and g(c)>=g(d) with respect to the function g(x) that indicates the respective pixel values, the function between the pixel b and the pixel c is given as Equation (1) as described above. That is, in the embodiment of the present invention as illustrated in FIG. 6B, if the function value of the pixels is changed from higher to lower, unlike the conventional interpolation, the concerned section is processed as a curve using the quadratic function, and this prevents an abrupt change at a vertex.

Referring to FIG. 6C, the function value of the four adjacent pixels is not increased (in the section a-b), decreased (in the section b-c), and then increased (in the section c-d). In this case, the concerned section b-c is processed as a curve of a quadratic function. That is, if g(a)>=g(b), g(b)>g(c), and g(c)<g(d) with respect to the function g(x) that indicates the respective pixel values, the function between the pixel b and the pixel c is given by Equation (2) below.
f(x)=−(g(c)−g(b))*(x-c-1)(x-b)+g(b) (2)

In Equation (2), b-a=c-b=d-c=1.

That is, in the embodiment of the present invention as illustrated in FIG. 6C, if the function value of the pixels is changed from higher to lower, unlike the conventional interpolation, the concerned section is processed as a curve using the quadratic function, and this prevents an abrupt change at a vertex.

Referring to FIG. 6D, the function value of the four adjacent pixels is not decreased (in the section a-b), increased (in the section b-c), and then decreased (in the section c-d). In this case, the concerned section b-c is processed as a curve of a quadratic function. That is, if g(a)<=g(b), g(b)<g(c), and g(c)>g(d) with respect to the function g(x) that indicates the respective pixel values, the function between the pixel b and the pixel c is given by Equation (2) above. That is, in the embodiment of the present invention as illustrated in FIG. 6D, if the function value of the pixels is changed from lower to higher, unlike the conventional interpolation, the concerned section is processed as a curve using the quadratic function, and this prevents an abrupt change at a vertex.

As illustrated in FIGS. 6A to 6D, if the function value of the pixels is changed from higher to lower or from lower to higher, the concerned section is not processed as a straight line, but is processed as a curve. This causes the change between the pixels to be smooth, not abrupt, as in the conventional art. Therefore, the resultant image becomes more similar to an analog image.

Four adjacent pixels are compared with each another to prevent the distortion of image. That is, if the function value is increased as a positive quadratic function and then decreased as a negative quadratic function, the distortion becomes more severe than that occurring in the process as a straight line, and vice versa. For example, if the section c-d is different from that as illustrated in FIGS. 6A to 6D, it is processed as a straight line as in the conventional interpolation method rather than a curve according to the present invention.

Although, in the embodiment of the present invention, the concerned section between the pixels is processed as a smooth curve using the quadratic function in order to reduce the amount of calculation, the present invention is not limited thereto. More specifically, the quadratic function of Equation (1) or Equation (2) can be implemented in diverse forms such as a sine function, a square root function, a log function, etc. However, in the case of the implementation in other forms, the amount of calculation becomes greater than that of the quadratic function according to the preferred embodiment of the present invention.

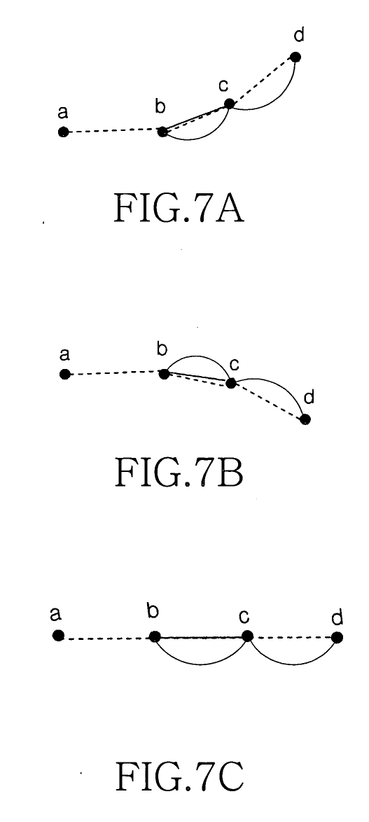

FIGS. 7A to 7C are views illustrating exceptional sections of interpolation methods for respective image signal types according to a method of expanding a digital image according to the present invention.

FIG. 7A illustrates a case in which the concerned sections continuously increase such as g(a)=<g(b)=<g(c)=<g(d). As illustrated as a solid line in FIG. 7A, if the section b-c is processed as a curve and then the section c-d is processed as a curve, the distortion occurs more severely than that occurring in the straight-line process. Accordingly, in this case, the function for the interpolation between the pixels is processed as a straight line in the same manner as the conventional interpolation method.

FIG. 7B illustrates a case in which the concerned sections are continuously decreasing such as g(a)=>g(b)=>g(c)=>g(d). As illustrated as a solid line in FIG. 7B, if the section b-c is processed as a curve and then the section c-d is processed as a curve, the distortion occurs more severely than that occurring in the straight-line process. Accordingly, in this case, the function for the interpolation between the pixels is processed as a straight line in the same manner as the conventional interpolation method.

FIG. 7C illustrates a case in which the concerned sections are constant such as g(a)=g(b)=g(c)=g(d). As illustrated as a solid line in FIG. 7C, if the section b-c is processed as a curve and then the section c-d is processed as a curve, the distortion occurs more severely than that occurring in the straight-line process. Accordingly, in this case, the function for the interpolation between the pixels is processed as a straight line in the same manner as the conventional interpolation method.

According to the method of expanding the digital image according to the present invention as illustrated in FIGS. 6A to 6D and 7A to 7C, the respective image is processed in the unit of four adjacent pixels. Accordingly, the process of the section a-b, which refers to the process of the four initial pixels, may cause a problem, and in this case, the section a-b can be processed by the conventional interpolation method or the up-sampling method. Also, the two final pixels can be processed by the conventional interpolation method or the up-sampling method, or by the method according to the present invention, which is performed in the case that the section c-d is constant.

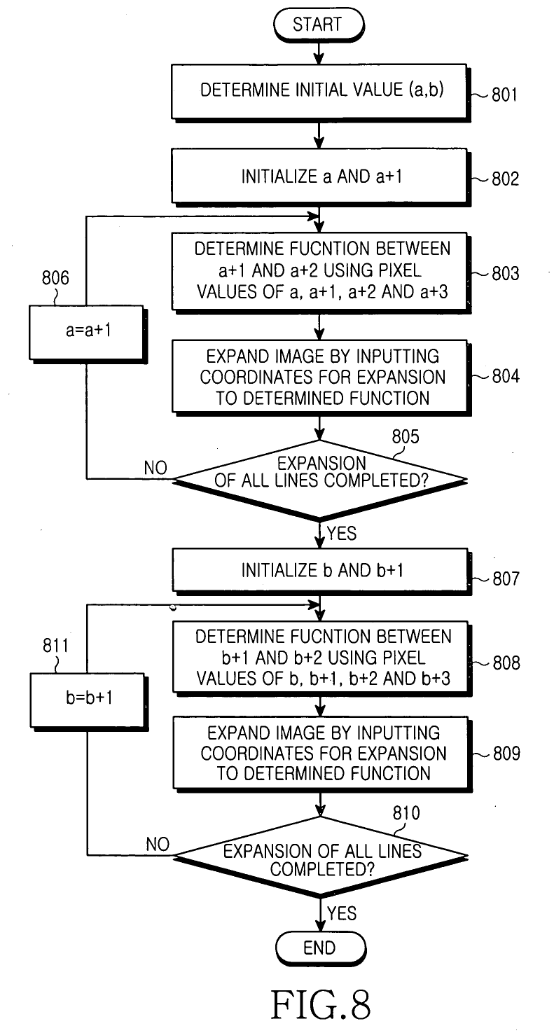

FIG. 8 is a flowchart illustrating a method of expanding a digital image according to the present invention. Referring to FIG. 8, the initial value according to the present invention is determined in step 801. The initial value includes variable a that indicates a pixel in a horizontal direction of an input image, variable b that indicates a pixel in a vertical direction, F1 that indicates an end of the image in the horizontal direction, and F2 that indicates an end of the image in the vertical direction. Here, a and b are set to “0”.

In the embodiment of the present invention, in order to expand the digital image, four adjacent pixels and a function for expansion between the second pixel and the third pixel are analyzed. However, the first pixel (a=0) and the second pixel (a=1) are processed through initialization in step 802.

By analyzing the four adjacent pixels a, a+1, a+2, and a+3, an interpolation function for expansion between the second pixel a+1 and the third pixel a+2 is determined in step 803. In this case, the function for expansion is determined by dividing the four pixels into three sections, i.e., a first section between a and a+1, a second section between a+1 and a+2, and a third section between a+2 and a+3, and analyzing types of the respective sections using a function value g(x) corresponding to the respective pixel. If the function value of the four adjacent pixels is decreased in the first section, increased in the second section, and not decreased in the third section, the function as shown in Equation (3) below is determined.

If the function value is increased in the first section, decreased in the second section, and not increased in the third section, the function as shown in Equation (3) is determined. If the function value is not increased in the first section, decreased in the second section, and increased in the third section, the function as shown in Equation (4) below is determined.

If the function value is not decreased in the first section, increased in the second section, and decreased in the third section, the function as shown in Equation (4) is determined. In other cases, a straight-line function as shown in Equation (5) below is determined.
f(x)={g(a+2)−g(a+1)}*^{(x-(a+1))}^{²}+g(a+1) (3)

In Equation (3), the space between the respective pixels is “1”.
f(x)=−(g(a+2)−g(a+1))*(x−(a+2)−1)(x−(a+1))+g(a+1) (4)

In Equation (4), the space between the respective pixels is “1”.
f(x)=(g(a+2)−g(a+1))*(x−(a+1))+g(a+1) (5)

In Equation (5), the space between the respective pixels is “1”.

According to the present invention, Equations (3) to (5) are described as the functions for expansion. However, the present invention is not limited thereto.

By inputting coordinate values for expansion to the determined function, the corresponding function values are obtained, and the image is expanded through the corresponding coordinate values and function values in step 804. Then, it is confirmed whether the expansion of all the lines is completed in step 805.

If the expansion of all the lines is not completed, the value of a that is the start pixel is increased by 1 and step 806 is performed, but if the expansion of all the lines is completed, the expansion in the vertical direction is performed. In this case, the change of the order of the horizontal and vertical directions is within the scope of the present invention.

Thereafter, the first pixel (b=0) and the second pixel (b=1) are processed through initialization in step 807. By analyzing the four adjacent pixels b, b+1, b+2, and b+3, an interpolation function for expansion between the second pixel b+1 and the third pixel b+2 is determined in step 808.

In this case, the function for expansion is determined by dividing the four pixels into three sections, i.e., a first section between b and b+1, a second section between b+1 and b+2, and a third section between b+2 and b+3, and analyzing types of the respective sections using a function value g(x) corresponding to the respective pixel. If the function value of the four adjacent pixels decreases in the first section, increases in the second section, and does not decrease or decrease in the third section, the function as shown in Equation (6) below is determined.

If the function value increases in the first section, decreases in the second section, and does not increases or decrease in the third section, the function as shown in Equation (6) is determined.

If the function value does not increases or decrease in the first section, decreases in the second section, and increases in the third section, the function as shown in Equation (7) below is determined.

If the function value does not decreases or increase in the first section, increases in the second section, and decreases in the third section, the function as shown in Equation (7) is determined.

In other cases, a straight-line function as shown in Equation (8) below is determined.
f(x)={g(b+2)−g(b+1)}*^{(x-(b+))}^{²}+g(b+1) (6)

In Equation (6), the space between the respective pixels is “1”.
f(x)=−(g(b+2)−g(b+1))*(x−(b+2)−1)(x−(b+1))+g(b+1) (7)

In Equation (7), the space between the respective pixels is “1”.
f(x)=(g(b+2)−g(b+1))*(x−(b+1))+g(b+1) (8)

In Equation (8), the space between the respective pixels is “1”.

According to the present invention, Equations (6) to (8) are used to describe the functions for expansion. However, the present invention is not limited thereto.

By inputting coordinate values for expansion to the determined function, the corresponding function values are obtained, and the image is expanded through the corresponding coordinate values and function values in step 809. It is confirmed whether the expansion of all the lines is completed in step 810.

If the expansion of all the lines is not completed, the value of b that is the start pixel is increased by 1 in step 811 and the step 808 is performed. However, if the expansion of all the lines is completed, the expansion is ended.

If the method of determining the function for interpolation of the digital image is not provided as a quadratic function or provided as a general curve function, the function may be provided using a derivative value. More specifically, if the function value of the four adjacent pixels is decreased in the first section, increased in the second section, and not decreased or increased in the third section, a curve function having a positive first-derivative value and a positive second-derivative value in the second section is determined. If the function value is increased in the first section, decreased in the second section, and not increased or decreased in the third section, a curve function having a negative derivative value and a negative second-derivative value in the second section is determined.

If the function value is not increased in the first section, decreased in the second section, and increased in the third section, a curve function having a negative derivative value and a positive second-derivative value in the second section is determined. If the function value is not decreased in the first section, increased in the second section, and decreased in the third section, a curve function having a positive derivative value and a negative second-derivative value in the second section is determined.

Consequently, according to another embodiment of the present invention, the function for interpolating the digital image can be determined by determining the shape of the curve using the first-derivative value and the second derivative-value and allocating the curve corresponding to the shape.

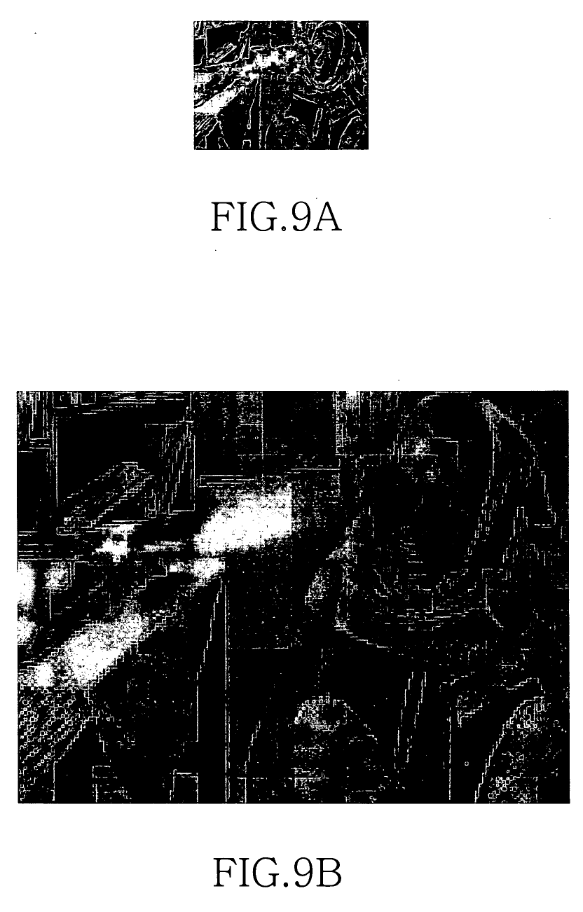

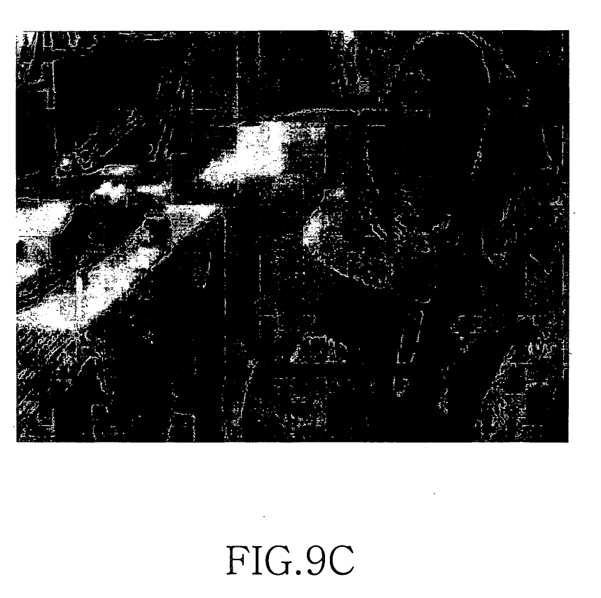

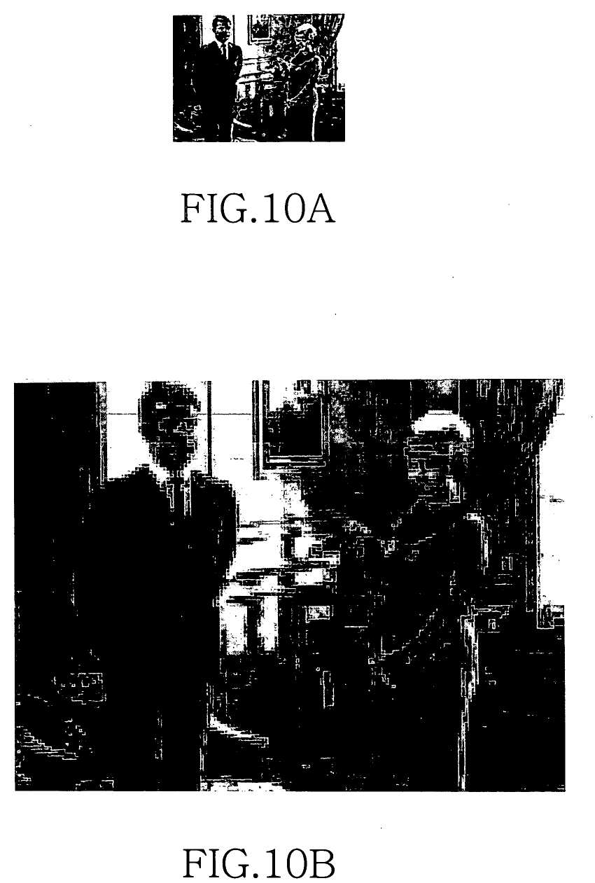

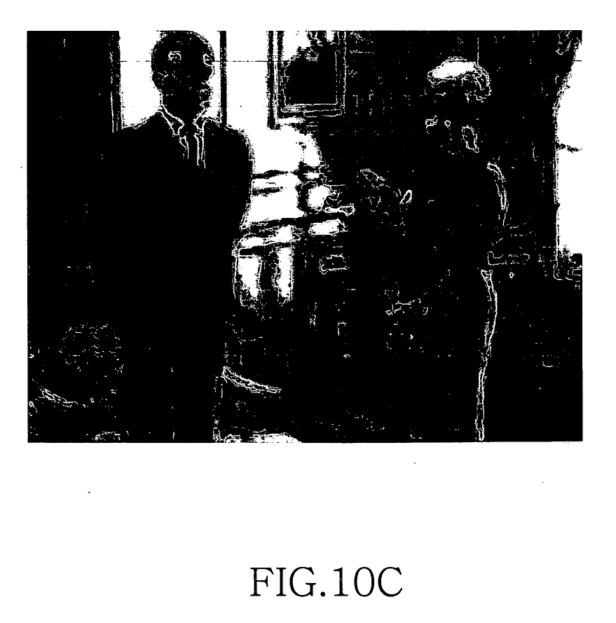

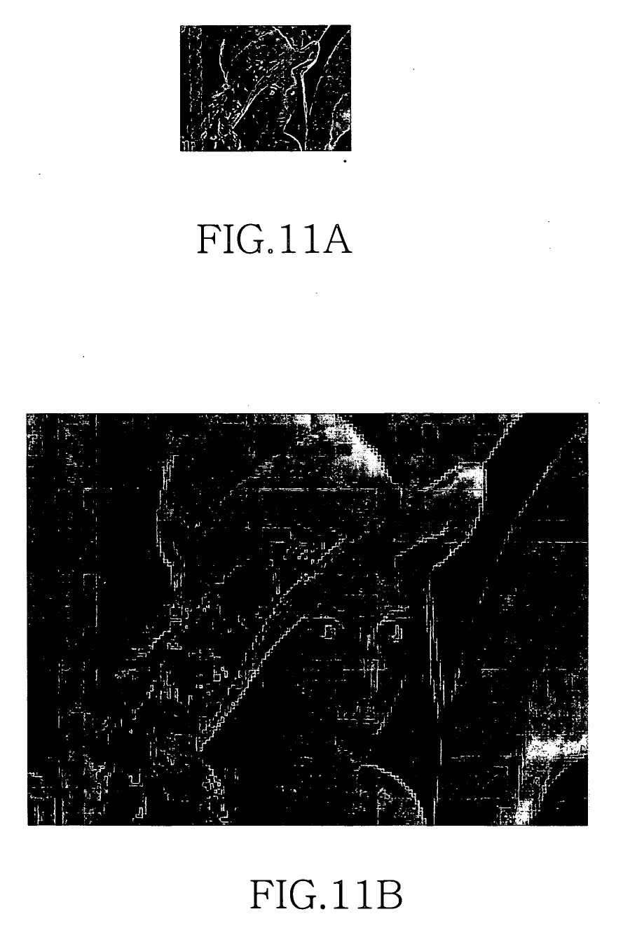

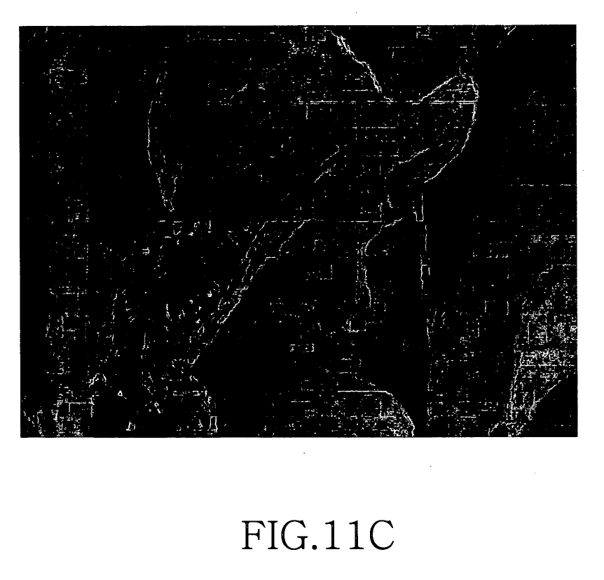

FIGS. 9A to 9C, 10A to 10C and 11A to 11C are views illustrating digital images expanded according to the present invention. More specifically, FIGS. 9A, 10A and 11A show the original images, FIGS. 9B, 10B and 11B show the images expanded by the up-sampling method, and FIGS. 9C, 10C and 11C show the images expanded according to the present invention.

Referring to FIGS. 9 to 9C, 10A to 10C and 11A to 11C, it can be seen that the digital image expanded according to the embodiment of the present invention has a great picture quality in comparison to the digital image expanded according to the conventional up-sampling method.

Additionally, the method according to the present invention as described above can be implemented by a program, and stored in a recording medium such as a CD-ROM, RAM, floppy disc, hard disc, optomagnetic disc, etc., in a form readable by a computer.

As described above, the method of expanding a digital image according to the present invention reduces distortion of the image in a video communication, a VOD (Video On Demand) service, etc., by widening a communication bandwidth by encoding the image with a small size and expanding and reproducing the image on a terminal side.

Also, the present invention can provide desired images with a reduced distortion in diverse multimedia appliances.

Further, the present invention can efficiently expand an image signal to provide an expanded image similar to that obtained using a digital appliance having a large number of pixels.

Additionally, the present invention can obtain an expanded image of an object by heightening the scale of expansion of a digital zoom as a pre-processing step of the digital image obtaining.

While the present invention has been shown and described with reference to certain preferred embodiments thereof, it will be understood by those skilled in the art that various changes in form and details may be made therein without departing from the spirit and scope of the invention as defined by the appended claims.

1. A method of expanding a digital image, comprising:
(a) dividing an input image in the unit of four adjacent pixels;
(b) dividing the four pixels into three sections;
(c) determining an interpolation function between the second and third pixels among the four adjacent pixels by analyzing the digital image every three sections;
(d) setting coordinate values for image expansion using the interpolation function; and
(e) obtaining an expanded image of the digital image by repeating steps (c) and (d), until a last line of the digital image is processed.

2. The method as claimed in claim 1, further comprising:
(f) determining the interpolation function between the first pixel and the second pixel for each line of the input digital image to be a straight-line function between the first pixel and the second pixel.

3. The method as claimed in claim 1, wherein the step (c) comprises dividing in order the four adjacent pixels into a first section between the first pixel and the second pixel, a second section between the second pixel and the third pixel, and a third section between the third pixel and the fourth pixel.

4. The method as claimed in claim 3, wherein the step (d) comprises:
(g) determining the interpolation function as a curve function having a positive first-derivative value and a positive second-derivative value in the second section, if a function value of the four adjacent pixels is decreased in the first section, increased in the second section, and unchanged in the third section;
(h) determining the interpolation function as a curve function having a negative derivative value and a negative second-derivative value in the second section, if the function value is increased in the first section, decreased in the second section, and not changed in the third section;
(i) determining the interpolation function as a curve function having a negative derivative value and a positive second-derivative value in the second section, if the function value is not changed in the first section, decreased in the second section, and increased in the third section;
(j) determining the interpolation function as a curve function having a positive derivative value and a negative second-derivative value in the second section, if the function value is not changed in the first section, increased in the second section, and decreased in the third section; and
(k) determining the interpolation function as a straight-line function between the second pixel and the third pixel of the second section, if conditions of the steps (g) to (j) are not satisfied.

5. The method as claimed in claim 4, wherein the curve function at the step (g) is given by:
f(x)={g(c)−g(b)}*^{(x-b)}^{²}+g(b)
wherein a denotes the first pixel, b the second pixel, c the third pixel, d the fourth pixel, b-a=c-b=d-c=1, and g(x) a digital image signal curve function of the pixel x.

6. The method as claimed in claim 4, wherein the curve function at the step (h) is given by:
f(x)={g(c)−g(b)}*^{(x-b)}^{²}+g(b)
wherein a denotes the first pixel, b the second pixel, c the third pixel, d the fourth pixel, b-a=c-b=d-c=1, and g(x) a digital image signal curve function of the pixel x.

7. The method as claimed in claim 4, wherein the curve function at the step (i) is given by:
f(x)=−(g(c)−g(b))*(x-c-1)(x-b)+g(b)
wherein a denotes the first pixel, b the second pixel, c the third pixel, d the fourth pixel, b-a=c-b=d-c=1, and g(x) a digital image signal curve function of the pixel x.

8. The method as claimed in claim 4, wherein the curve function at the step (j) is given by:
f(x)=−(g(c)−g(b))*(x-c-1)(x-b)+g(b)
wherein a denotes the first pixel, b the second pixel, c the third pixel, d the fourth pixel, b-a=c-b=d-c=1, and g(x) a digital image signal curve function of the pixel x.
